(19) United States
(12) Patent Application Publication
(10) Pub. No.: US 2020/0279282 A1
(43) Pub. Date: Sep. 3, 2020

(54) INTERFACING WITH A COMPUTER-IMPLEMENTED ENTERPRISE RESOURCE PLANNING SYSTEM FOR INVENTORY MANAGEMENT

(71) Applicant: Bayer Aktiengesellschaft, Leverkusen (DE)

(72) Inventors: Frank Gümmer, Koln (DE); Mark Andrew Southgate, Hillsborough, NC (US); Angela Wilson, Durham, NC (US); Tao Wang, Cary, NC (US); Gregory James Dibble, JR., Dusseldorf (DE)

(21) Appl. No.: 16/290,411

(22) Filed: Mar. 1, 2019

(51) Int. Cl. G06Q 30/02; G06Q 10/08

(52) U.S. Cl. CPC G06Q 30/0203; G06F 3/0481; G06Q 10/0838

(57) ABSTRACT

A method is provided for inventory management from an apparatus with application software coupled with an enterprise resource planning (ERP) system and a back-office support system via respective middleware. The method includes the apparatus accessing and receiving a bill of lading from the ERP system, and executing a questionnaire in a graphical user interface (GUI) to gather user input that indicates a quantity of received products relative to a quantity of the shipped products. The questionnaire includes logic that controls which questions are presented in the GUI and in what sequence. The apparatus determines if the quantities of received and shipped products match based on the bill of lading and the user input. And the apparatus records the receipt of the shipment in the ERP system, or sends a notification to the back-office support system, depending on whether the quantities match or deviate from one another.

### TECHNOLOGICAL FIELD

The present disclosure relates generally to computer-implemented enterprise resource planning (ERP) systems and, in particular, to an improved system to interface with an ERP system for inventory management.

### BACKGROUND

A supply chain is generally a network of entities involved in the production and distribution of a product from supplier to customer. The supply chain may include supplier and customer locations from which the product is shipped and received, either or both of which may be a warehouse. The supply chain may also include a shipping company responsible for shipping the product from the supplier to the customer. Even further, the supply chain may additionally include a number of technologies that facilitate the production and distribution of the product from supplier to customer.

In some industries, the supplier uses a computer-implemented enterprise resource planning (ERP) system to manage many of its business processes including the distribution of products to various supplier locations, as well as to customer locations. These receiving locations may also use the ERP system to manage and track shipments of product into and out of those locations. In cases of a third-party shipping company, the shipping company may utilize a similar system—or more generally a computer-implemented back-office support system—to manage and track shipments.

The conventional process by which a receiving location receives and posts a shipment into an ERP system offers limited guidance. This can and sometimes does lead to the wrong information/situation being inputted and saved into the ERP system, resulting in a misalignment of inventory positions and resulting action(s). This can in turn create exponentially more work to re-balance the system inventory positions, and in general the process is slow and encompasses an undesirable number of process steps.

Therefore it would be desirable to have a system and method that takes into account at least some of the issues discussed above, as well as other possible issues.

### BRIEF SUMMARY

In view of the foregoing background, example implementations of the present disclosure are directed to an improved system to interface with a computer-implemented enterprise resource planning (ERP) system for inventory management. The present disclosure includes, without limitation, the following example implementations.

Some example implementations provide a method of inventory management from an apparatus with application software coupled with an enterprise resource planning (ERP) system and a back-office support system via respective middleware, the ERP system being configured to store a bill of lading for a shipment, including a quantity of one or more confirmed shipped products, the method comprising executing the application software to cause the apparatus to generate a visual environment including a graphical user interface (GUI) to record receipt of the shipment, including the apparatus: accessing the ERP system, and receiving the bill of lading from the ERP system; executing a questionnaire in the GUI to gather user input that indicates a quantity of one or more confirmed received products relative to the quantity of the one or more confirmed shipped products, the questionnaire including a plurality of questions and logic that controls which questions of the plurality of questions are presented in the GUI and in what sequence the questions are presented; determining if the quantity of the one or more confirmed received products matches the quantity of the one or more confirmed shipped products based on the bill of lading and the user input; and recording the receipt of the shipment in the ERP system when the quantity of the one or more confirmed received products matches the quantity of the one or more confirmed shipped products, the receipt of the shipment being recorded in the ERP system automatically without further user input; or sending a notification of deviation to the back-office support system when the quantity of the one or more confirmed received products deviates from the quantity of the one or more confirmed shipped products.

In some example implementations of the method of any preceding example implementation, or any combination of any preceding example implementations, the quantity of the one or more confirmed shipped products, and the quantity of the one or more confirmed received products, are identified by respective unique production batch numbers, and wherein the apparatus determines if the quantity of the one or more confirmed received products matches the quantity of the one or more confirmed shipped products further based on the respective unique production batch numbers.

In some example implementations of the method of any preceding example implementation, or any combination of any preceding example implementations, executing the questionnaire includes executing the questionnaire to gather further user input that indicates damage to at least one of the one or more confirmed received products or a container thereof, and wherein recording the receipt of the shipment further includes sending a notification of the damage to the back-office support system to take a corresponding remedial action.

In some example implementations of the method of any preceding example implementation, or any combination of any preceding example implementations, executing the questionnaire includes executing the questionnaire to gather further user input that indicates first and second ones of the one or more confirmed received products match first and second ones of confirmed shipped products but in quantities that are respectively more and less than the first and second ones of the confirmed shipped products, and wherein sending the notification of deviation includes sending the notification indicating the quantities that are respectively more and less than the first and second ones of the confirmed shipped products, and sending the notification of deviation further includes blocking recordation of the receipt of the shipment in the ERP system.

In some example implementations of the method of any preceding example implementation, or any combination of any preceding example implementations, executing the questionnaire includes executing the questionnaire to gather further user input that indicates damage to at least one of the one or more confirmed received products or a container thereof, and wherein sending the notification of deviation further includes sending a notification of the damage to the back-office support system to take a corresponding remedial action.

In some example implementations of the method of any preceding example implementation, or any combination of any preceding example implementations, executing the questionnaire includes executing the questionnaire to gather further user input that indicates the quantity of the one or more confirmed received products includes a matching quantity that matches the quantity of the one or more confirmed shipped products, and also an additional quantity of the one or more confirmed received products or an additional confirmed received product, and wherein sending the notification of deviation includes sending the notification indicating the additional quantity.

In some example implementations of the method of any preceding example implementation, or any combination of any preceding example implementations, executing the questionnaire includes executing the questionnaire to gather further user input that indicates damage to at least one of the one or more confirmed received products or a container thereof, and wherein sending the notification of deviation further includes sending a notification of the damage to the back-office support system to take a corresponding remedial action.

In some example implementations of the method of any preceding example implementation, or any combination of any preceding example implementations, executing the questionnaire includes executing the questionnaire to gather further user input that indicates the quantity of the one or more confirmed received products is less than the quantity of the one or more confirmed shipped products by a missing quantity of the one or more confirmed received products, and wherein sending the notification of deviation includes sending the notification indicating the missing quantity.

In some example implementations of the method of any preceding example implementation, or any combination of any preceding example implementations, executing the questionnaire includes executing the questionnaire to gather further user input that indicates damage to at least one of the one or more confirmed received products or a container thereof, and wherein sending the notification of deviation further includes sending a notification of the damage to the back-office support system to take a corresponding remedial action.

Some example implementations provide an apparatus or inventory management, the apparatus comprising a memory storing application software coupled with an ERP system and a back-office support system via respective middleware, the ERP system being configured to store a bill of lading for a shipment; and processing circuitry configured to access the memory, and execute the application software to cause the apparatus to generate a visual environment including a GUI to record receipt of the shipment, including the apparatus being caused to at least perform the method of any preceding example implementation, or any combination of any preceding example implementations.

Some example implementations provide a computer-readable storage medium, being non-transitory and having computer-readable program code stored therein that in response to execution by processing circuitry, causes an apparatus to at least perform the method of any preceding example implementation, or any combination of any preceding example implementations.

Features, aspects, and advantages of the present disclosure will be apparent from a reading of the following detailed description together with the accompanying drawings, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable, unless the context of the disclosure clearly dictates otherwise.

### BRIEF DESCRIPTION OF THE DRAWING(S)

Having thus described the disclosure in general terms, reference will now be made to the accompanying drawings, which are not necessarily drawn to scale, and wherein:

FIG. 1 illustrates a system for inventory management, according to example implementations of the present disclosure;

FIG. 2 is a flowchart illustrating various steps in a method of managing inventory, according to example implementations;

FIGS. 3A, 3B, 3C, 3D, 3E and 3F are flowcharts illustrating various steps in a method of managing inventory, according to more particular example implementations; and

FIG. 4 illustrates an apparatus according to example implementations.

### DETAILED DESCRIPTION

Some implementations of the present disclosure will now be described more fully hereinafter with reference to the accompanying drawings, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. As used herein, for example, the singular forms “a”, “an”, “the” and the like include plural referents unless the context clearly dictates otherwise. The terms “data”, “information”, “content” and similar terms may be used interchangeably, according to some example implementations of the present invention, to refer to data capable of being transmitted, received, operated on, and/or stored. Also, for example, reference may be made herein to quantitative measures, values, relationships or the like. Unless otherwise stated, any one or more if not all of these may be absolute or approximate to account for acceptable variations that may occur, such as those due to engineering tolerances or the like. Like reference numerals refer to like elements throughout.

As explained in the Background section, in a typical supply chain, a computer-implemented enterprise resource planning (ERP) system may be used to manage the distribution of products to various supplier locations, as well as to customer locations. But the conventional process by which a receiving location receives and posts a shipment into an ERP system offers limited guidance. This can and sometimes does lead to the wrong information/situation being inputted and saved into the ERP system, resulting in a misalignment of inventory positions, which can in turn create exponentially more work to re-balance the system inventory positions and resulting action(s), and in general the process is slow and encompasses an undesirable number of process steps.

Example implementations of the present disclosure are general directed to an improved system to interface with a computer-implemented enterprise resource planning (ERP) system for inventory management. Example implementations address the problem of how a third-party receiving location (e.g., warehouse) user interfaces with an ERP system to record receipt of a delivery.

In particular, example implementations of the present disclose provide application software executable to generate a visual environment including a graphical user interface (GUI) to record receipt of a shipment. This includes utility-based logic to guide the user through the receipt process in a step-wise, question-based approach that diagnoses the order situation and determines the correct course of action. The logic is based on a questionnaire and user input that controls the questions presented in the GUI. Based on the user input, the application software can direct an ERP system transaction, prohibit the transaction and initiate appropriate personnel to remedy the delivery issue, or conduct a partial receipt process. Again, the logic identifies the situation and directs the appropriate course of action.

The application software connects to the ERP system via middleware that allows the user to use the application software to do the process without having to directly engage the ERP system. The ERP process does not change. The application software instead provides an improved technique for capturing the correct situation. The application software speeds up the entry process tenfold or more over the conventional process, and reduces if not completely eliminates order entry errors. It also captures necessary information to enable one to derive performance metrics and mobilize stewardship efforts for damage product situations.

The utility-based logic also allows incorporation of scanning technology to allow the user scan in the delivery rather than having to manually enter the information into the application software. This is significant in terms of speed, the further reduction of user error and enables the implementation of other measures in data aggregation into the value chain.

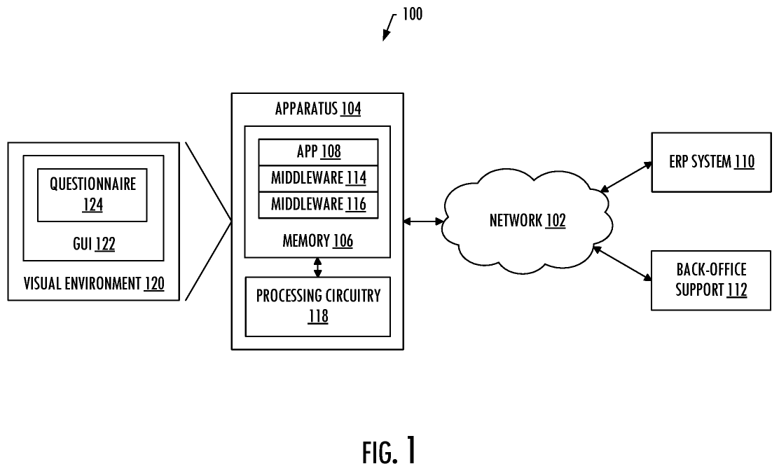

FIG. 1 illustrates a system 100 according to example implementations of the present disclosure. The system may include any of a number of different subsystems (each an individual system) for performing one or more functions or operations. As shown, the system may be implemented with an Internet-based computing architecture including a computer network or a number of interconnected computer networks 102 in or over which a number of systems, platforms, computers and the like communicate or otherwise operate. As also shown, in some examples, the system includes an apparatus 104 with a memory 106 storing application software 108 coupled with an ERP system 110 and a back-office support system 112 via respective middleware 114, 116. The ERP system in particular is configured to store a bill of lading for a shipment, including a quantity of one or more confirmed shipped products. In some examples, in the supply chain, the apparatus and ERP system are operable by a supplier, customer, and/or shipping company responsible for shipping product to a receiving location of the supplier or customer. In some examples, the back-office support system is operable by the shipping company.

The apparatus 104 further includes processing circuitry 118 configured to access the memory 106, and execute the application software 108 to cause the apparatus 104 to generate a visual environment 120 including a graphical user interface (GUI) 122 to record receipt of the shipment. This includes the apparatus being caused to access the ERP system 110, and receive the bill of lading from the ERP system.

The apparatus 104 is caused to execute a questionnaire 124 in the GUI 122 to gather user input that indicates a quantity of one or more confirmed received products relative to the quantity of the confirmed shipped product(s). The questionnaire includes a plurality of questions and logic that controls which questions of the plurality of questions are presented in the GUI 122 and in what sequence the questions are presented.

The apparatus 104 is caused to determine if the quantity of the confirmed received product(s) matches the quantity of the confirmed shipped product(s) based on the bill of lading and the user input. In some examples, the quantity of the confirmed shipped product(s), and the quantity of the confirmed received product(s), are identified by respective unique production batch numbers. In these examples, the apparatus is caused to determine if the quantity of the confirmed received product(s) matches the quantity of the confirmed shipped product(s) further based on the respective unique production batch numbers.

The apparatus 104 is further caused to record the receipt of the shipment in the ERP system 110, automatically without further user input, when the quantity of the confirmed received product(s) matches the quantity of the confirmed shipped product(s). Or when the quantity of the confirmed received product(s) deviates from the quantity of the confirmed shipped product(s), the apparatus is caused to send a notification of deviation to the back-office support system 112. This and other notifications may be sent to the back-office support system in any of a number of different manners, such as by email or some other technology for exchanging messages, notifications or the like.

In some examples, the apparatus 104 is caused to execute the questionnaire 124 to gather further user input that indicates first and second ones of the confirmed received product(s) match first and second ones of confirmed shipped products but in quantities that are respectively more and less than the first and second ones of the confirmed shipped products. In these examples, the apparatus is caused to send the notification of deviation indicating the quantities that are respectively more and less than the first and second ones of the confirmed shipped products. And the apparatus is caused to block recordation of the receipt of the shipment in the ERP system 110.

In some examples, the apparatus 104 is caused to execute the questionnaire 124 to gather further user input that indicates the quantity of the confirmed received product(s) includes a matching quantity that matches the quantity of the confirmed shipped product(s), and also an additional quantity of the confirmed received product(s) or an additional confirmed received product. In these examples, the apparatus is caused to send the notification of deviation indicating the additional quantity.

In some examples, the apparatus 104 is caused to execute the questionnaire 124 to gather further user input that indicates the quantity of the confirmed received product(s) is less than the quantity of the confirmed shipped product(s) by a missing quantity of the confirmed received product(s). In these examples, the apparatus is caused to send the notification of deviation indicating the missing quantity.

In some further examples, the apparatus 104 is caused to execute the questionnaire 124 to gather further user input that indicates damage to at least one of the confirmed received product(s) or a container thereof. In these examples, the apparatus being caused to send the notification of deviation further includes the apparatus being caused to send a notification of the damage to the back-office support system 112 to take a corresponding remedial action.

When a product is damaged, the user input may include information to enable an understanding of the nature of the damage, which may be beneficial for a number of different reasons. The damage situation may dictate how the product is classified in the ERP system 110. If the issue is just damaged packaging, the remedial action may include sending replacement packaging and organizing the re-labeling, re-casing, re-palletization and related activities. Notification sent according to example implementations enables much more efficient coordination and execution of these remedial actions.

If the damage includes release of product from its primary container, additional or alternative remedial action(s) may be taken. In this situation, it may be beneficial to understand what happened as well as what was done to mitigate the release of product. Relevant personnel may be dispatched to assess the situation, mobilize support and document the situation for record retention, insurance claims, etc. In addition, personnel may use the information to ensure organization of the next steps with regard to handling and disposal. The same or other personnel may manage the situation in the ERP system 110.

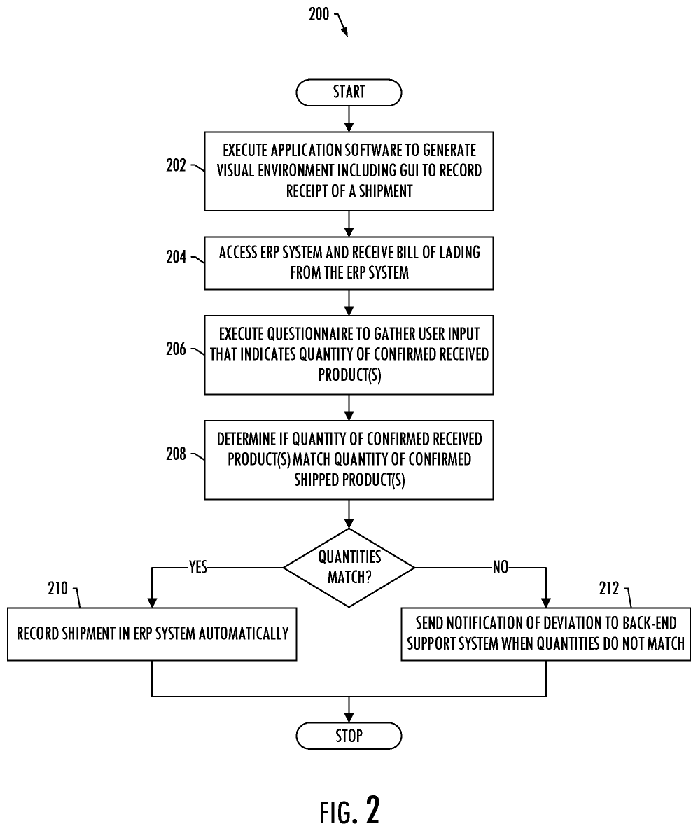

FIG. 2 is a flowchart illustrating various steps in a method 200 of managing inventory from an apparatus 104 with application software 108 coupled with an ERP system 110 and a back-office support system 112 via respective middleware 114, 116, the ERP system being configured to store a bill of lading for a shipment, including a quantity of one or more confirmed shipped products. A shown at block 202, the method includes executing the application software to cause the apparatus to generate a visual environment 120 including a GUI 122 to record receipt of the shipment. This includes the apparatus accessing the ERP system, and receiving the bill of lading from the ERP system, as shown at block 204. It also includes the apparatus executing a questionnaire 124 in the GUI to gather user input that indicates a quantity of one or more confirmed received products relative to the quantity of the confirmed shipped product(s), the questionnaire including a plurality of questions and logic that controls which questions of the plurality of questions are presented in the GUI and in what sequence the questions are presented, as shown at block 206.

The apparatus 104 being caused to generate the visual environment 120 to record receipt of the shipment further includes the apparatus determining if the quantity of the confirmed received product(s) matches the quantity of the confirmed shipped product(s) based on the bill of lading and the user input, as shown at block 208. It also includes the apparatus recording the receipt of the shipment in the ERP system 110 when the quantity of the confirmed received product(s) matches the quantity of the confirmed shipped product(s), the receipt of the shipment being recorded in the ERP system automatically without further user input, as shown at block 210. And it includes the apparatus sending a notification of deviation to the back-office support system 112 when the quantity of the confirmed received product(s) deviates from the quantity of the confirmed shipped product(s), as shown at block 212.

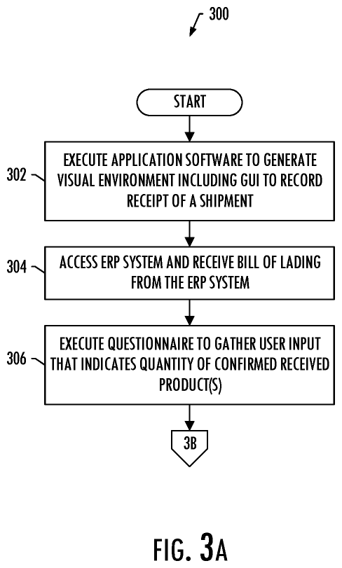

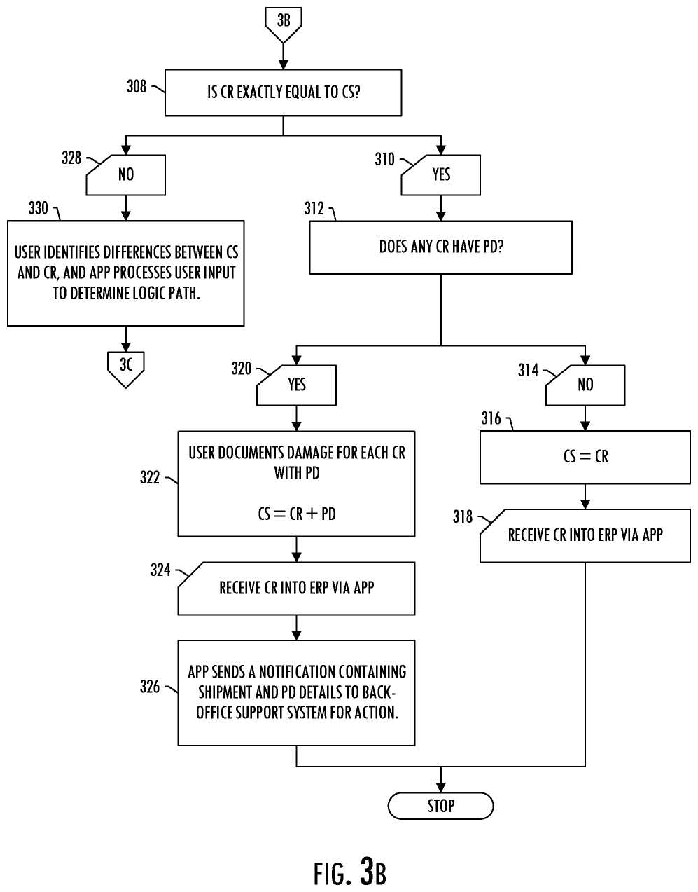

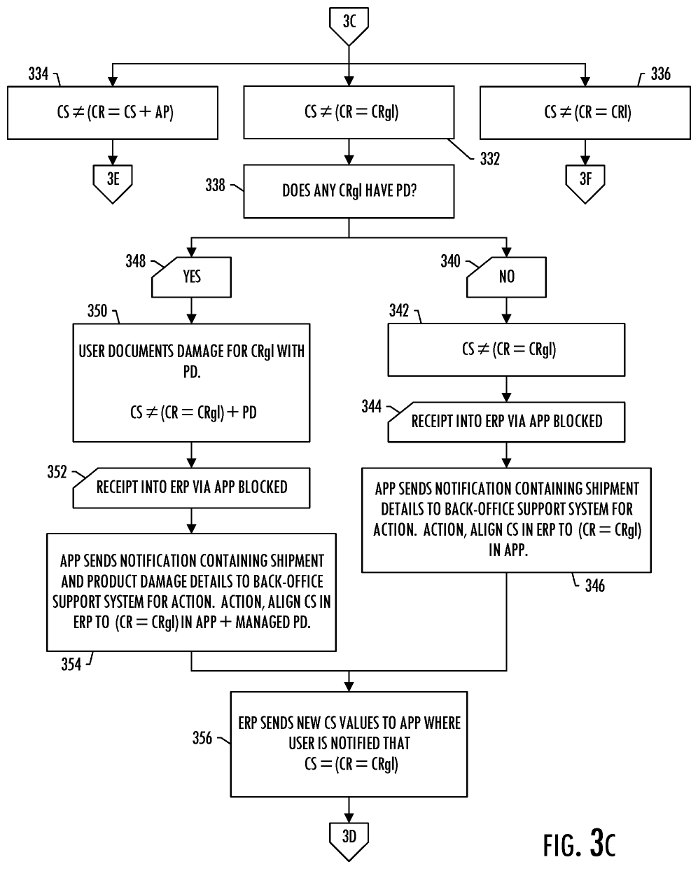

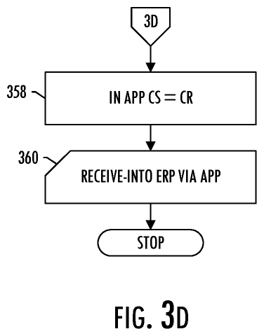

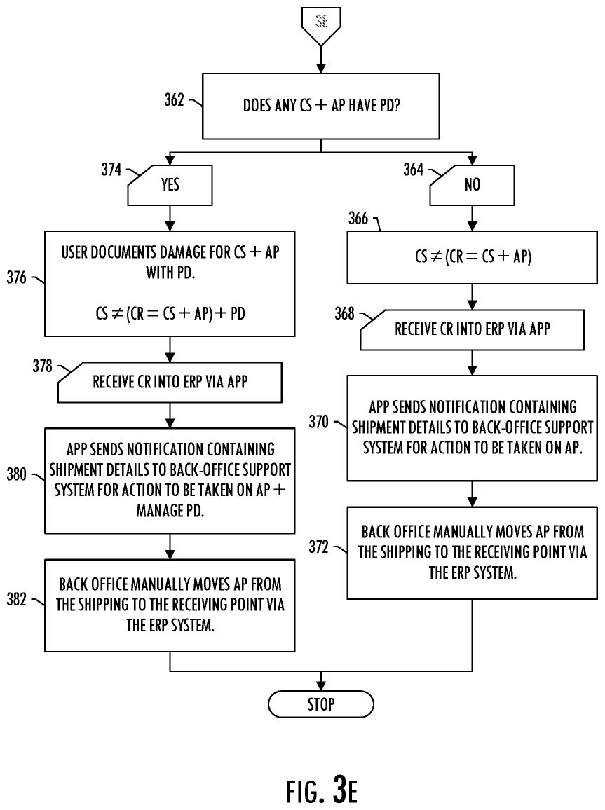

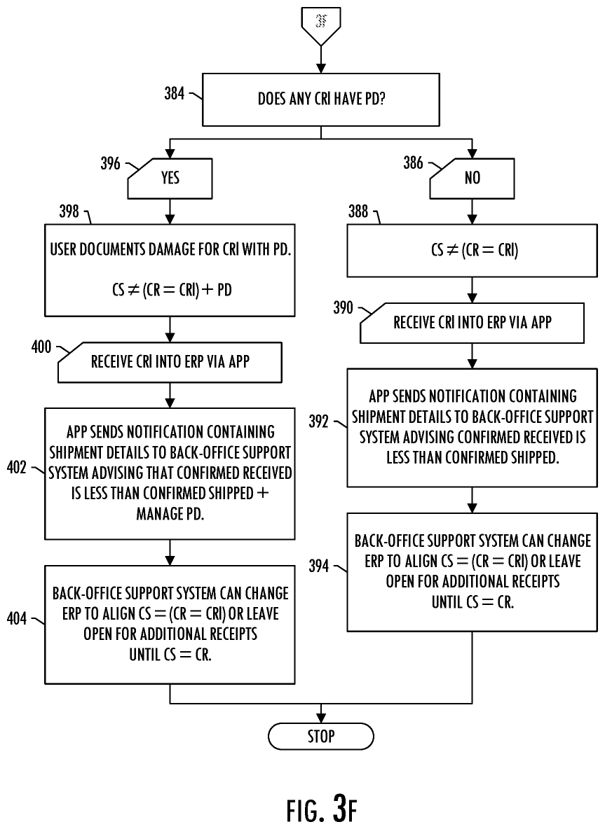

To further illustrate example implementations of the present disclosure, reference is now drawn to FIGS. 3A, 3B, 3C, 3D, 3E and 3F, which are flowcharts illustrating various steps in a method 300 of managing inventory, according to more particular example implementations of the present disclosure. In the flowcharts, the following acronyms are used:
CS—The quantity of confirmed shipped product(s)
CR—The quantity of confirmed received product(s)
CRg1—A first confirmed received product (CR) matches a first confirmed shipped product (CS) but greater in quantity (more than), and a second confirmed received product (CR) matches a second confirmed shipped product (CS) but fewer in quantity (less than)
CR1—The quantity of the confirmed received product(s) (CR) is less than the quantity of the confirmed shipped products (CS)
AP—The quantity of the confirmed received product(s) (CR) includes a matching quantity that matches the quantity of the confirmed shipped product(s) (CS), and also an additional quantity of the confirmed received product(s) or an additional confirmed received product (a product not listed on the bill of lading)
PD—Indicates damage to at least one of the confirmed received product(s) or a container thereof

As described in greater detail below, the method 300 of managing inventory generally involves the application software 108 receiving and diagnosing user input on the delivery situation to determine if what was confirmed shipped (CS) by the ERP system 110 matches what was confirmed received (CR), and independently, whether any product has damage. If they do not match (nothing more, nothing less), the application software captures user input to understand the imbalance. The application software looks for a number of different situations. Does CS CR, because at least one product was confirmed received (CR) at a quantity greater than the confirmed shipped (CS) quantity, and where at least one product was confirmed received (CR) at a quantity less than the confirmed shipped (CS) quantity (CRg1)? Or does CS≠CR, because at least one product was confirmed received (CR) at a quantity less than the confirmed shipped (CS) quantity (CR1)? Or does CS=CR, but in addition the receiving location received more product for one of the confirmed received product(s), or the receiving location received a different product all together (AP)? Depending on the situation, the application software determines what information needs to be solicited from the user to trigger the appropriate action—action being in the ERP system 110 and/or how the back-office support system 112 is informed to support.

The application software 108 also captures user input relating to damaged product situations. This is coupled with the above logic that for diagnosing the delivery situation. This provides a number of benefits, including capturing all information at the time of entry, in a standardized comprehensive way, and that is integrated to a document and communication system that notifies all back office parties of the situation so that the ERP system 110 is updated appropriately, and those on the supply chain are able to support necessary safety and stewardship protocols.

Turning now to FIG. 3A, in a manner similar to that described above, the method includes executing the application software 108 to cause the apparatus 104 to generate a visual environment 120 including a GUI 122 to record receipt of a shipment, including a quantity of one or more confirmed shipped products, as shown at block 302. This includes the apparatus accessing the ERP system 110, and receiving the bill of lading from the ERP system, as shown at block 304. It also includes the apparatus executing a questionnaire 124 in the GUI to gather user input that indicates a quantity of one or more confirmed received products relative to the quantity of the confirmed shipped product(s), the questionnaire including a plurality of questions and logic that controls which questions of the plurality of questions are presented in the GUI and in what sequence the questions are presented, as shown at block 306.

As shown at block 308 in FIG. 3B, the questionnaire 124 includes a question to ask the user if CR is exactly equal to (matches) CS. When the user input indicates “yes,” as shown at block 310, the questionnaire logic controls presentation of the next question to ask the user if any CR has damage (PD), as shown at block 312. When the user input indicates “no,” as shown at block 314, CS=CR and receipt of the shipment is automatically recorded in the ERP system 110, as shown at blocks 316 and 318. When the user input indicates “yes” to reflect that at least one CR has PD, as shown 320, the questionnaire logic controls presentation of the next question or questions to document the PD into the application software 108, as shown at block 322. The CR is received into the ERP system 110 via the application software, and the application software sends a notification of the damage to the back-office support system 112 to take a corresponding remedial action on the PD, as shown at blocks 324 and 326.

As indicated above, when a product is damaged, the user input may include information to enable an understanding of the nature of the damage. This information may include, for example, product name or other identifier, quantity and/or batch number, and perhaps images of the damaged product. In the case of chemical products in particular, for example, the information may indicate if the damage resulted in a chemical release, where the damage occurred, and what has been done to mitigate the situation. In addition, user input may also allow the user to request new labels for products that did not suffer a chemical release—where packing needs to be replaced.

When the user input indicates “no” to reflect that CR does not exactly equal (match) CS, as shown at block 328, the questionnaire logic controls presentation of the next question or questions to allow the user to identify differences between CS and CR, with the application software 108 processing the user input to compare the difference(s) to determine the logic path through the questionnaire 124, as shown at block 330. Three situations are indicated in FIG. 3C. These include situations in which (CS≠(CR=CRg1)), (CS≠(CR=CR1)) and (CS≠(CR=CS+AP)), as shown at respectively blocks 332, 334 and 336.

When the user input indicates that (CS≠(CR=CRg1), the questionnaire logic controls presentation of the next question to ask the user if any CRg1 has damage (PD), as shown at block 338. When the user input indicates “no,” as shown at block 340, (CS≠(CR=CRg1) and recordation of the receipt of the shipment (CR) in the ERP system 110 is blocked, as shown at blocks 342 and 344. The application software 108 may also send a notification of deviation to the back-office support system 112, indicating the quantities that are respectively more and less than the first and second ones of the confirmed shipped products, as shown at block 346.

When the user input indicates “yes” to reflect that at least one CRg1 has PD, as shown 348, the questionnaire logic controls presentation of the next question or questions to document the PD into the application software 108, as shown at block 350. Again, recordation of the CS=CR+PD situation into the ERP system 110 via the application software is blocked, as shown at block 352. Also similar to before, the application software may send a notification of deviation to the back-office support system 112, as well as the product damage, as shown at block 354.

Further in the situation in which (CS≠(CR=CRg1), the back-office support system 112 may align CS in the ERP system 110 with CR in the application software 108, and the ERP system may send new CS values to the application software to notify the user that (CS=(CR=CRg1), again as shown at block 356. In the application software, then, CS=CR and receipt of the shipment is automatically recorded in the ERP system 110, as shown at blocks 358 and 360 of FIG. 3D.

As shown at block 362 in FIG. 3E, when the user input indicates that (CS≠(CR=CS+AP)), the questionnaire logic controls presentation of the next question to ask the user if any (CS+AP) has damage (PD). When the user input indicates “no,” as shown at block 364, (CS≠(CR=CS+AP)) and receipt of the shipment (CR) is recorded in the ERP system 110, as shown at blocks 366 and 368. The application software 108 may also send a notification of deviation to the back-office support system 112, indicating the additional quantity of CR or additional confirmed received product, as shown at block 370. The back-office support system may manually move the AP from the shipping to the receiving point via the ERP system, as shown at block 372. That is, the back-office support system may manage the movement of stock in ERP system for the additional product received (AP) from the shipping location to the receiving location.

When the user input indicates “yes” to reflect that at least one (CS+AP) has PD, as shown 374, the questionnaire logic controls presentation of the next question or questions to document the PD into the application software 108, as shown at block 376. Again, the CS≠(CR=CS+AP)+PD situation is recorded into the ERP system 110 via the application software, as shown at block 378. Also similar to before, the application software may send a notification of deviation to the back-office support system 112 to indicate the additional quantity of CR or additional confirmed received product, as well as the product damage, as shown at block 380. And back-office support system may manually move the AP from the shipping to the receiving point via the ERP system (move stock in ERP system for the AP from the shipping location to the receiving location), as shown at block 382.

Turning now to FIG. 3F, when the user input indicates that (CS≠(CR=CR1), the questionnaire logic controls presentation of the next question to ask the user if any CR1 has damage (PD), as shown at block 384. When the user input indicates “no,” as shown at block 386, (CS≠(CR=CR1) and receipt of the shipment (CR) is recorded in the ERP system 110, as shown at blocks 388 and 390. The application software 108 may also send a notification of deviation to the back-office support system 112, indicating the missing quantity of CR, as shown at block 392. The back-office support system may align CS in the ERP system 110 with CR in the application software 108, or leave the shipment open in the ERP system until CS=CR, as shown at block 394.

When the user input indicates “yes” to reflect that at least one CR1 has PD, as shown 396, the questionnaire logic controls presentation of the next question or questions to document the PD into the application software 108, as shown at block 398. Again, the CS≠(CR=CR1)+PD situation is recorded into the ERP system 110 via the application software, as shown at block 400. Also similar to before, the application software may send a notification of deviation to the back-office support system 112 to indicate the missing quantity, as well as the product damage, as shown at block 402. And back-office support system may align CS in the ERP system with CR in the application software, or leave the shipment open in the ERP system until CS=CR, as shown at block 404.

According to example implementations of the present disclosure, the system 100 and its subsystems including the apparatus 104, ERP system 110 and back-office support system 112 may be implemented by various means. Means for implementing the system and its subsystems may include hardware, alone or under direction of one or more computer programs from a computer-readable storage medium. In some examples, one or more computers may be configured to function as or otherwise implement the system and its subsystems shown and described herein. In examples involving more than one computer, the respective computers may be connected to or otherwise in communication with one another in a number of different manners, such as directly or indirectly via a wired or wireless network (e.g., network 102) or the like.

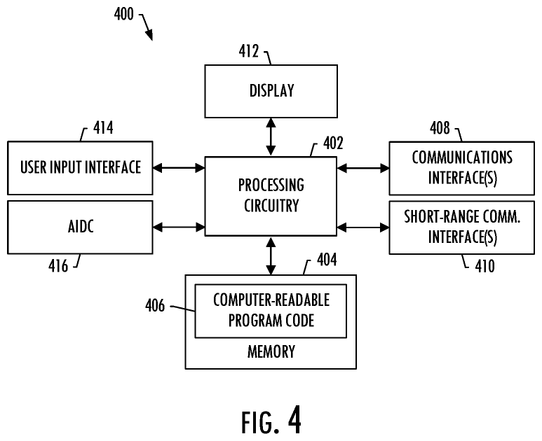

FIG. 4 illustrates a computer 400 according to some example implementations of the present disclosure. Generally, a computer of exemplary implementations of the present disclosure may comprise, include or be embodied in one or more fixed or portable electronic devices. The computer may include one or more of each of a number of components such as, for example, processing circuitry 402 connected to a memory 404 (e.g., storage device). In the case of the apparatus 104, for example, the processing circuitry 402 and memory 404 may correspond to respectively processing circuitry 118 and memory 106.

The processing circuitry 402 may be composed of one or more processors alone or in combination with one or more memories. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). The processing circuitry may be configured to execute computer programs, which may be stored onboard the processing circuitry or otherwise stored in the memory 404 (of the same or another computer).

The processing circuitry 402 may be a number of processors, a multi-core processor or some other type of processor, depending on the particular implementation. Further, the processing circuitry may be implemented using a number of heterogeneous processor systems in which a main processor is present with one or more secondary processors on a single chip. As another illustrative example, the processing circuitry may be a symmetric multi-processor system containing multiple processors of the same type. In yet another example, the processing circuitry may be embodied as or otherwise include one or more ASICs, FPGAs or the like. Thus, although the processing circuitry may be capable of executing a computer program to perform one or more functions, the processing circuitry of various examples may be capable of performing one or more functions without the aid of a computer program. In either instance, the processing circuitry may be appropriately programmed to perform functions or operations according to example implementations of the present disclosure.

The memory 404 is generally any piece of computer hardware that is capable of storing information such as, for example, data, computer programs (e.g., computer-readable program code 406) and/or other suitable information either on a temporary basis and/or a permanent basis. In the case of the apparatus 104, this computer-readable program code may include application software 108 and middleware 114, 116. The memory may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk-read/write (CD-R/W), DVD or the like. In various instances, the memory may be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

In addition to the memory 404, the processing circuitry 402 may also be connected to one or more interfaces for displaying, transmitting and/or receiving information. The interfaces may include one or more communications interfaces and/or one or more user interfaces. The communications interface(s) may be configured to transmit and/or receive information, such as to and/or from other computer(s), network(s) or the like. The communications interface may be configured to transmit and/or receive information by physical (wired) and/or wireless communications links. The communications interface(s) may include interface(s) 408 to connect to a network (e.g., network 102), such as using technologies such as cellular telephone, Wi-Fi, satellite, cable, digital subscriber line (DSL), fiber optics and the like. In some examples, the communications interface(s) may include one or more short-range communications interfaces 410 configured to connect devices using short-range communications technologies such as NFC, RFID, Bluetooth, Bluetooth LE, ZigBee, infrared (e.g., IrDA) or the like.

The user interfaces may include a display 412 and/or one or more user input interfaces 414. The display may be configured to present or otherwise display information to a user, suitable examples of which include a liquid crystal display (LCD), light-emitting diode display (LED), plasma display panel (PDP) or the like. The user input interfaces may be wired or wireless, and may be configured to receive information from a user into the computer 400, such as for processing, storage and/or display. Suitable examples of user input interfaces include a microphone, image or video capture device, keyboard or keypad, joystick, touch-sensitive surface (separate from or integrated into a touchscreen) or the like. In some examples, the user interfaces may include automatic identification and data capture (AIDC) technology 416 for machine-readable information. This may include barcode, radio frequency identification (RFID), magnetic stripes, optical character recognition (OCR), integrated circuit card (ICC), and the like. The user interfaces may further include one or more interfaces for communicating with peripherals such as printers and the like.

As indicated above, program code instructions may be stored in memory, and executed by processing circuitry that is thereby programmed, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, processing circuitry or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processing circuitry or other programmable apparatus to configure the computer, processing circuitry or other programmable apparatus to execute operations to be performed on or by the computer, processing circuitry or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

Execution of instructions by processing circuitry, or storage of instructions in a computer-readable storage medium, supports combinations of operations for performing the specified functions. In this manner, a computer 400 may include processing circuitry 402 and a computer-readable storage medium or memory 404 coupled to the processing circuitry, where the processing circuitry is configured to execute computer-readable program code 406 stored in the memory. It will also be understood that one or more functions, and combinations of functions, may be implemented by special purpose hardware-based computer systems and/or processing circuitry which perform the specified functions, or combinations of special purpose hardware and program code instructions.

As explained above, the present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable, unless the context of the disclosure clearly dictates otherwise.

Many modifications and other implementations of the disclosure set forth herein will come to mind to one skilled in the art to which the disclosure pertains having the benefit of the teachings presented in the foregoing description and the associated drawings. Therefore, it is to be understood that the disclosure is not to be limited to the specific implementations disclosed and that modifications and other implementations are intended to be included within the scope of the appended claims. Moreover, although the foregoing description and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus for inventory management, the apparatus comprising:
a memory storing application software coupled with an enterprise resource planning (ERP) system and a back-office support system via respective middleware, the ERP system being configured to store a bill of lading for a shipment, including a quantity of one or more confirmed shipped products; and
processing circuitry configured to access the memory, and execute the application software to cause the apparatus to generate a visual environment including a graphical user interface (GUI) to record receipt of the shipment, including the apparatus being caused to at least:
access the ERP system, and receive the bill of lading from the ERP system;
execute a questionnaire in the GUI to gather user input that indicates a quantity of one or more confirmed received products relative to the quantity of the one or more confirmed shipped products, the questionnaire including a plurality of questions and logic that controls which questions of the plurality of questions are presented in the GUI and in what sequence the questions are presented;
determine if the quantity of the one or more confirmed received products matches the quantity of the one or more confirmed shipped products based on the bill of lading and the user input; and
record the receipt of the shipment in the ERP system when the quantity of the one or more confirmed received products matches the quantity of the one or more confirmed shipped products, the receipt of the shipment being recorded in the ERP system automatically without further user input; or
send a notification of deviation to the back-office support system when the quantity of the one or more confirmed received products deviates from the quantity of the one or more confirmed shipped products.

2. The apparatus of claim 1, wherein the quantity of the one or more confirmed shipped products, and the quantity of the one or more confirmed received products, are identified by respective unique production batch numbers, and
wherein the apparatus is caused to determine if the quantity of the one or more confirmed received products matches the quantity of the one or more confirmed shipped products further based on the respective unique production batch numbers.

3. The apparatus of claim 1, wherein the apparatus being caused to execute the questionnaire includes being caused to execute the questionnaire to gather further user input that indicates damage to at least one of the one or more confirmed received products or a container thereof, and
wherein the apparatus being caused to record the receipt of the shipment further includes the apparatus being caused to send a notification of the damage to the back-office support system to take a corresponding remedial action.

4. The apparatus of claim 1, wherein the apparatus being caused to execute the questionnaire includes being caused to execute the questionnaire to gather further user input that indicates first and second ones of the one or more confirmed received products match first and second ones of confirmed shipped products but in quantities that are respectively more and less than the first and second ones of the confirmed shipped products, and
wherein the apparatus being caused to send the notification of deviation includes the apparatus being caused to send the notification indicating the quantities that are respectively more and less than the first and second ones of the confirmed shipped products, and the apparatus being caused to send the notification of deviation further includes the apparatus being caused to block recordation of the receipt of the shipment in the ERP system.

5. The apparatus of claim 4, wherein the apparatus being caused to execute the questionnaire includes being caused to execute the questionnaire to gather further user input that indicates damage to at least one of the one or more confirmed received products or a container thereof, and
wherein the apparatus being caused to send the notification of deviation further includes the apparatus being caused to send a notification of the damage to the back-office support system to take a corresponding remedial action.

6. The apparatus of claim 1, wherein the apparatus being caused to execute the questionnaire includes being caused to execute the questionnaire to gather further user input that indicates the quantity of the one or more confirmed received products includes a matching quantity that matches the quantity of the one or more confirmed shipped products, and also an additional quantity of the one or more confirmed received products or an additional confirmed received product, and
wherein the apparatus being caused to send the notification of deviation includes the apparatus being caused to send the notification indicating the additional quantity.

7. The apparatus of claim 6, wherein the apparatus being caused to execute the questionnaire includes being caused to execute the questionnaire to gather further user input that indicates damage to at least one of the one or more confirmed received products or a container thereof, and
wherein the apparatus being caused to send the notification of deviation further includes the apparatus being caused to send a notification of the damage to the back-office support system to take a corresponding remedial action.

8. The apparatus of claim 1, wherein the apparatus being caused to execute the questionnaire includes being caused to execute the questionnaire to gather further user input that indicates the quantity of the one or more confirmed received products is less than the quantity of the one or more confirmed shipped products by a missing quantity of the one or more confirmed received products, and
wherein the apparatus being caused to send the notification of deviation includes the apparatus being caused to send the notification indicating the missing quantity.

9. The apparatus of claim 8, wherein the apparatus being caused to execute the questionnaire includes being caused to execute the questionnaire to gather further user input that indicates damage to at least one of the one or more confirmed received products or a container thereof, and
wherein the apparatus being caused to send the notification of deviation further includes the apparatus being caused to send a notification of the damage to the back-office support system to take a corresponding remedial action.

10. A method of inventory management from an apparatus with application software coupled with an enterprise resource planning (ERP) system and a back-office support system via respective middleware, the ERP system being configured to store a bill of lading for a shipment, including a quantity of one or more confirmed shipped products, the method comprising:
executing the application software to cause the apparatus to generate a visual environment including a graphical user interface (GUI) to record receipt of the shipment, including the apparatus:
accessing the ERP system, and receiving the bill of lading from the ERP system;
executing a questionnaire in the GUI to gather user input that indicates a quantity of one or more confirmed received products relative to the quantity of the one or more confirmed shipped products, the questionnaire including a plurality of questions and logic that controls which questions of the plurality of questions are presented in the GUI and in what sequence the questions are presented;
determining if the quantity of the one or more confirmed received products matches the quantity of the one or more confirmed shipped products based on the bill of lading and the user input; and
recording the receipt of the shipment in the ERP system when the quantity of the one or more confirmed received products matches the quantity of the one or more confirmed shipped products, the receipt of the shipment being recorded in the ERP system automatically without further user input; or
sending a notification of deviation to the back-office support system when the quantity of the one or more confirmed received products deviates from the quantity of the one or more confirmed shipped products.

11. The method of claim 10, wherein the quantity of the one or more confirmed shipped products, and the quantity of the one or more confirmed received products, are identified by respective unique production batch numbers, and
wherein the apparatus determines if the quantity of the one or more confirmed received products matches the quantity of the one or more confirmed shipped products further based on the respective unique production batch numbers.

12. The method of claim 10, wherein executing the questionnaire includes executing the questionnaire to gather further user input that indicates damage to at least one of the one or more confirmed received products or a container thereof, and
wherein recording the receipt of the shipment further includes sending a notification of the damage to the back-office support system to take a corresponding remedial action.

13. The method of claim 10, wherein executing the questionnaire includes executing the questionnaire to gather further user input that indicates first and second ones of the one or more confirmed received products match first and second ones of confirmed shipped products but in quantities that are respectively more and less than the first and second ones of the confirmed shipped products, and
wherein sending the notification of deviation includes sending the notification indicating the quantities that are respectively more and less than the first and second ones of the confirmed shipped products, and sending the notification of deviation further includes blocking recordation of the receipt of the shipment in the ERP system.

14. The method of claim 13, wherein executing the questionnaire includes executing the questionnaire to gather further user input that indicates damage to at least one of the one or more confirmed received products or a container thereof, and
wherein sending the notification of deviation further includes sending a notification of the damage to the back-office support system to take a corresponding remedial action.

15. The method of claim 10, wherein executing the questionnaire includes executing the questionnaire to gather further user input that indicates the quantity of the one or more confirmed received products includes a matching quantity that matches the quantity of the one or more confirmed shipped products, and also an additional quantity of the one or more confirmed received products or an additional confirmed received product, and
wherein sending the notification of deviation includes sending the notification indicating the additional quantity.

16. The method of claim 15, wherein executing the questionnaire includes executing the questionnaire to gather further user input that indicates damage to at least one of the one or more confirmed received products or a container thereof, and
wherein sending the notification of deviation further includes sending a notification of the damage to the back-office support system to take a corresponding remedial action.

17. The method of claim 10, wherein executing the questionnaire includes executing the questionnaire to gather further user input that indicates the quantity of the one or more confirmed received products is less than the quantity of the one or more confirmed shipped products by a missing quantity of the one or more confirmed received products, and
wherein sending the notification of deviation includes sending the notification indicating the missing quantity.

18. The method of claim 17, wherein executing the questionnaire includes executing the questionnaire to gather further user input that indicates damage to at least one of the one or more confirmed received products or a container thereof, and
wherein sending the notification of deviation further includes sending a notification of the damage to the back-office support system to take a corresponding remedial action.

19. A computer-readable storage medium for inventory management, the computer-readable storage medium being non-transitory and having stored therein computer-readable program code coupled with an enterprise resource planning (ERP) system and a back-office support system via respective middleware, the ERP system being configured to store a bill of lading for a shipment, including a quantity of one or more confirmed shipped products, the computer-readable program code being executable by processing circuitry to cause an apparatus to:
generate a visual environment including a graphical user interface (GUI) to record receipt of the shipment, including the apparatus being caused to at least:
access the ERP system, and receive the bill of lading from the ERP system;
execute a questionnaire in the GUI to gather user input that indicates a quantity of one or more confirmed received products relative to the quantity of the one or more confirmed shipped products, the questionnaire including a plurality of questions and logic that controls which questions of the plurality of questions are presented in the GUI and in what sequence the questions are presented;
determine if the quantity of the one or more confirmed received products matches the quantity of the one or more confirmed shipped products based on the bill of lading and the user input; and
record the receipt of the shipment in the ERP system when the quantity of the one or more confirmed received products matches the quantity of the one or more confirmed shipped products, the receipt of the shipment being recorded in the ERP system automatically without further user input; or
send a notification of deviation to the back-office support system when the quantity of the one or more confirmed received products deviates from the quantity of the one or more confirmed shipped products.

20. The computer-readable storage medium of claim 19, wherein the quantity of the one or more confirmed shipped products, and the quantity of the one or more confirmed received products, are identified by respective unique production batch numbers, and
wherein the apparatus is caused to determine if the quantity of the one or more confirmed received products matches the quantity of the one or more confirmed shipped products further based on the respective unique production batch numbers.

21. The computer-readable storage medium of claim 19, wherein the apparatus being caused to execute the questionnaire includes being caused to execute the questionnaire to gather further user input that indicates damage to at least one of the one or more confirmed received products or a container thereof, and
wherein the apparatus being caused to record the receipt of the shipment further includes the apparatus being caused to send a notification of the damage to the back-office support system to take a corresponding remedial action.

22. The computer-readable storage medium of claim 19, wherein the apparatus being caused to execute the questionnaire includes being caused to execute the questionnaire to gather further user input that indicates first and second ones of the one or more confirmed received products match first and second ones of confirmed shipped products but in quantities that are respectively more and less than the first and second ones of the confirmed shipped products, and
wherein the apparatus being caused to send the notification of deviation includes the apparatus being caused to send the notification indicating the quantities that are respectively more and less than the first and second ones of the confirmed shipped products, and the apparatus being caused to send the notification of deviation further includes the apparatus being caused to block recordation of the receipt of the shipment in the ERP system.

23. The computer-readable storage medium of claim 22, wherein the apparatus being caused to execute the questionnaire includes being caused to execute the questionnaire to gather further user input that indicates damage to at least one of the one or more confirmed received products or a container thereof, and
wherein the apparatus being caused to send the notification of deviation further includes the apparatus being caused to send a notification of the damage to the back-office support system to take a corresponding remedial action.

24. The computer-readable storage medium of claim 19, wherein the apparatus being caused to execute the questionnaire includes being caused to execute the questionnaire to gather further user input that indicates the quantity of the one or more confirmed received products includes a matching quantity that matches the quantity of the one or more confirmed shipped products, and also an additional quantity of the one or more confirmed received products or an additional confirmed received product, and
wherein the apparatus being caused to send the notification of deviation includes the apparatus being caused to send the notification indicating the additional quantity.

25. The computer-readable storage medium of claim 24, wherein the apparatus being caused to execute the questionnaire includes being caused to execute the questionnaire to gather further user input that indicates damage to at least one of the one or more confirmed received products or a container thereof, and
wherein the apparatus being caused to send the notification of deviation further includes the apparatus being caused to send a notification of the damage to the back-office support system to take a corresponding remedial action.

26. The computer-readable storage medium of claim 19, wherein the apparatus being caused to execute the questionnaire includes being caused to execute the questionnaire to gather further user input that indicates the quantity of the one or more confirmed received products is less than the quantity of the one or more confirmed shipped products by a missing quantity of the one or more confirmed received products, and
wherein the apparatus being caused to send the notification of deviation includes the apparatus being caused to send the notification indicating the missing quantity.

27. The computer-readable storage medium of claim 26, wherein the apparatus being caused to execute the questionnaire includes being caused to execute the questionnaire to gather further user input that indicates damage to at least one of the one or more confirmed received products or a container thereof, and
wherein the apparatus being caused to send the notification of deviation further includes the apparatus being caused to send a notification of the damage to the back-office support system to take a corresponding remedial action.
